(19) United States
(12) Patent Application Publication
(10) Pub. No.: US 2019/0228055 A1
(43) Pub. Date: Jul. 25, 2019

(54) INFORMATION PROCESSING APPARATUS AND NON-TRANSITORY COMPUTER READABLE MEDIUM STORING INFORMATION PROCESSING PROGRAM

(71) Applicant: FUJI XEROX CO., LTD., Tokyo (JP)

(72) Inventor: Kenichiro WATANABE, Kanagawa (JP)

(73) Assignee: FUJI XEROX CO., LTD., Tokyo (JP)

(21) Appl. No.: 16/208,575

(22) Filed: Dec. 4, 2018

(30) Foreign Application Priority Data
Jan. 23, 2018 (JP) 2018-008515

(51) Int. Cl. G06F 17/22; H04L 12/58; G06F 16/93; G06F 16/22

(52) U.S. Cl. CPC G06F 17/2241; H04L 51/08; G06F 16/2246; G06F 17/2247; G06F 16/93; H04L 51/16

(57) ABSTRACT

An information processing apparatus includes a generation unit that generates correspondence relationship information between messages by using a history of communication which is performed by associating a document with the messages among plural users, an extraction unit that extracts a difference in a case where the document is updated, and a presentation unit that retrieves the difference from the correspondence relationship information, and presents a message on the basis of a retrieval result in the correspondence relationship information.

### CROSS-REFERENCE TO RELATED APPLICATIONS

This application is based on and claims priority under 35 USC 119 from Japanese Patent Application No. 2018-008515 filed Jan. 23, 2018.

### BACKGROUND

### (i) Technical Field

The present invention relates to an information processing apparatus and a non-transitory computer readable medium storing an information processing program.

### (ii) Related Art

JP2001-142801A discloses a technique in which, in order to provide a history managing method for document, which presents to a user a story of a will decision on matter exactly and easily comprehensibly, in the process of transmitting/receiving electronic mail, the history of updating an attached file is displayed; in the process of transmitting/receiving the electronic mail, it is displayed how many times the attached file is updated; identification information indicating that the attached file of the electronic mail is a file updated in the transmitting source is displayed; in a case where the user designates one of attached documents included in the history display, electronic mail information corresponding to this history is displayed; as the history of updating the attached file, a date on which this attached file is updated and the name of an updater are displayed; as the number of times of updating the attached file, the number of times at the time point of transmitting this attached file is displayed; and, as the number of times of updating the attached file, the number of times at the time point of retrieving this attached file is displayed.

### SUMMARY

A discussion is performed by using a communication tool such as an electronic mail. In this case, the discussion may be performed by associating a document with the electronic mail. In the middle of the discussion, the document is updated through a change thereof, and the document may be regarded as a final product of the discussion.

A history of the discussion remains in the communication tool. However, it is hard to check the previous discussion in order to understand a story of the update of the document.

Aspects of non-limiting embodiments of the present disclosure relate to an information processing apparatus and a non-transitory computer readable medium storing an information processing program capable of presenting a message associated with a difference occurring due to update of document by using correspondence relationship information between messages in communication of exchanging messages.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information processing apparatus including a generation unit that generates correspondence relationship information between messages by using a history of communication which is performed by associating a document with the messages among a plurality of users; an extraction unit that extracts a difference in a case where the document is updated; and a presentation unit that retrieves the difference from the correspondence relationship information, and presents a message on the basis of a retrieval result in the correspondence relationship information.

### BRIEF DESCRIPTION OF THE DRAWINGS

Exemplary embodiment(s) of the present invention will be described in detail based on the following figures, wherein:

FIG. 1 is a conceptual module configuration diagram illustrating a configuration example according to the present exemplary embodiment;

FIG. 2 is a diagram illustrating a system configuration example using the present exemplary embodiment;

FIG. 3 is a flowchart illustrating a process example according to the present exemplary embodiment;

FIG. 4 is a diagram illustrating a data structure example of a mail information table;

FIG. 5 is a diagram illustrating a data structure example of a change table;

FIG. 6 is a diagram illustrating a data structure example of a document change/story information table;

FIG. 7 is a diagram illustrating a process example according to the present exemplary embodiment;

FIG. 8 is a diagram illustrating a process example according to the present exemplary embodiment;

FIG. 9 is a diagram illustrating a process example according to the present exemplary embodiment;

FIG. 10 is a diagram illustrating a process example according to the present exemplary embodiment;

FIG. 11 is a diagram illustrating a display example according to the present exemplary embodiment;

FIG. 12 is a diagram illustrating a display example according to the present exemplary embodiment;

FIG. 13 is a diagram illustrating a display example according to the present exemplary embodiment;

FIGS. 14A to 14C are diagrams illustrating a process example according to the present exemplary embodiment;

FIG. 15 is a diagram illustrating a process example according to the present exemplary embodiment; and

FIG. 16 is a block diagram illustrating a hardware configuration example of a computer realizing the present exemplary embodiment.

### DETAILED DESCRIPTION

Hereinafter, with reference to the drawings, a description will be made of an exemplary embodiment for realizing the invention.

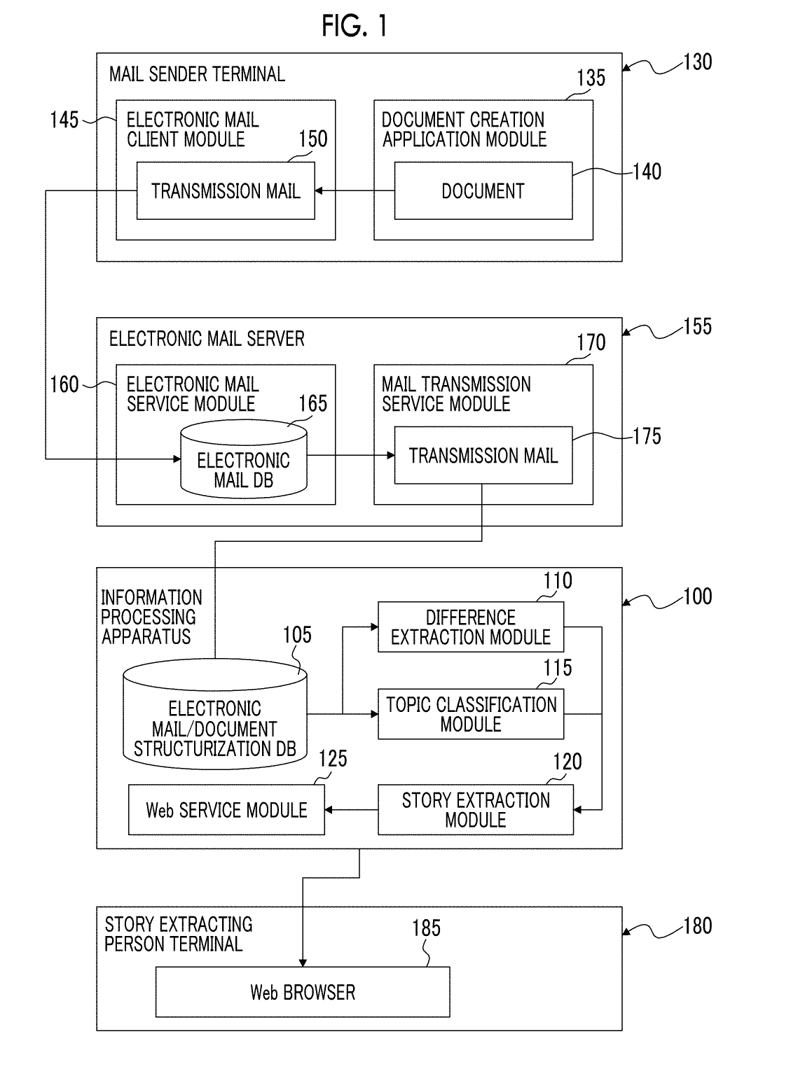

FIG. 1 is a conceptual module configuration diagram illustrating a configuration example according to the present exemplary embodiment.

The module generally indicates components such as software (computer program) or hardware which can be logically divided. Therefore, the module in the present exemplary embodiment indicates not only a module in a computer program but also a module in a hardware configuration. Therefore, in the present exemplary embodiment, a description will also be made of a computer program (a program causing a computer to execute each procedure, a program causing a computer to each unit, or a program a computer to realize each function), a system, and a method for functioning as such a module. However, for convenience of description, “storing”, “being stored”, or words equivalent thereto are used, but, these words indicate that a storage device stores data or a storage device is controlled to store data in a case where an exemplary embodiment is a computer program. A module may correspond to a function on a one-to-one basis, and, in installation, a single module may be configured with a single program, a plurality of modules may be configured with a single program, and, conversely, a single module may be configured with a plurality of programs. A plurality of modules may be executed by a single computer, and a single module may be executed by a plurality of computers in a distributed or parallel environment. Other modules may be included in a single module. Hereinafter, the term “connection” indicates only physical connection but also logical connection (transmission and reception of data, indication, a reference relationship between pieces of data, login, and the like). The term “setting in advance” indicates that setting is performed prior to a target process, and indicates not only that setting is performed before a process according to the present exemplary embodiment is started but also that, even after a process according to the present exemplary embodiment is started, setting is performed depending on a situation or a state at the time or a situation or a state hitherto in a case where a target process is not performed. In a case where there are “a plurality of preset values”, the values may be different from each other, and two or more values may be the same as each other (of course, including all of the values). The description that “in a case of A, B is performed” indicates that “it is determined whether or not A is satisfied, and, in a case where it is determined that A is satisfied, B is performed”. However, this excludes a case where determination of whether or not A is satisfied is unnecessary. In a case where objects are listed such as “A, B, and C”, the objects are exemplarily listed unless otherwise mentioned, and a case where only one thereof (for example, only A) is selected is included.

A system or an apparatus also includes not only a case where a plurality of computers, pieces of hardware, and apparatuses are configured to be connected to each other via a communication unit such as a network (including communication connection on a one-to-one basis) but also a case of being configured with a single computer, a single piece of hardware, and a single apparatus. The “apparatus” and the “system” are used as terms having an identical meaning. Of course, the “system” does not include systems that are merely a social “mechanism” (social system) which is an artificial arrangement.

Target information is read from a storage device, the process is performed, and a process result is written to the storage device for each process performed by each module or for each process in a case where a plurality of processes are performed in a module. Therefore, description of reading for a storage device before a process and writing for the storage device after the process will be omitted. The storage device here may include a hard disk, a random access memory (RAM), an external storage medium, a storage device connected via a communication line, a register in a central processing unit (CPU), or the like.

An information processing apparatus 100 according to the present exemplary embodiment performs a service of extracting a story of update of a document from messages exchanged by a communication tool in a case where a discussion is performed by using the communication tool, and the document is generated, and includes, as illustrated in an example in FIG. 1, an electronic mail/document structurization DB 105, a difference extraction module 110, a topic classification module 115, a story extraction module 120, and a web service module 125.

Due to wide spread of cloud services and diversification of communication, there are increasing circumstances where various people perform discussions online by using communication tools and cooperate to draw conclusions. The information processing apparatus 100 makes it possible to understand the process reaching consensus formation in the discussion and functions as a system extracting a document update story. As the “communication tool”, for example, there is an electronic mail, a chat, and a message transmission/reception function in a social networking service (SNS). As mentioned above, there are many communication tools, but an electronic mail has a high spread proportion, and is currently widely used as a communication tool. Hereinafter, examples will be described by using an electronic mail. However, the electronic mail is only an example, and a chat or a message transmission/reception function in an SNS may be used.

For example, the information processing apparatus 100 performs the following processes.

A story of a changed document is extracted from a plurality of electronic mails, and is presented to a user.

Particularly, it is assumed that a story is described in a location where a discussion is actively performed, and a quotation mark (“>” or the like) is focused. This is because quotation of text of a document or another electronic mail indicates that the discussion is performed as a result of being inspired by at least another electronic mail. There is a tendency that thoughts of various people are described in the surroundings of a sentence which is often quoted, and thus the electronic mail is extracted.

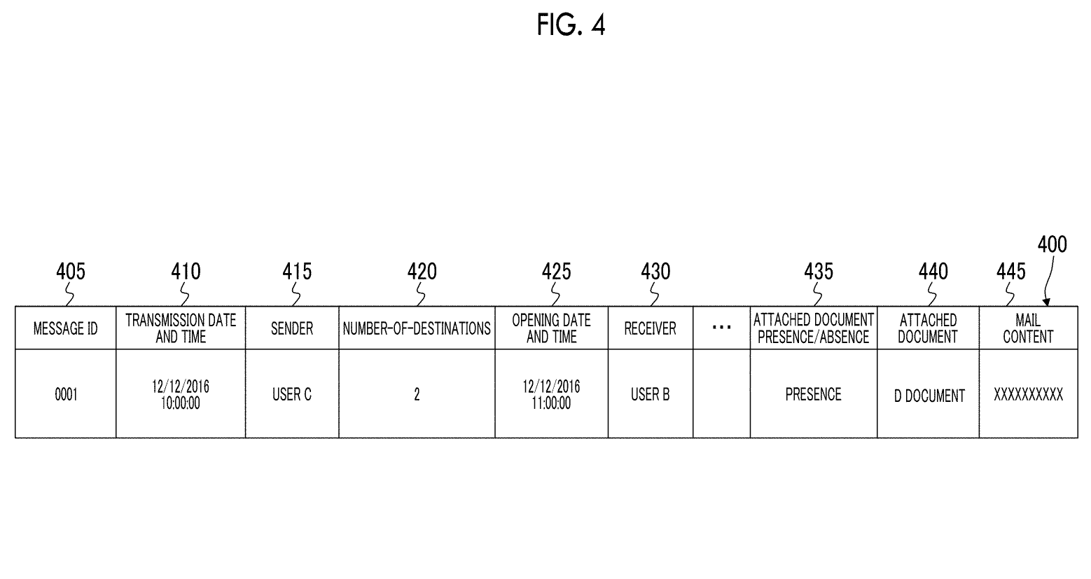

The electronic mail/document structurization DB 105 is connected to the difference extraction module 110, the topic classification module 115, and a mail transmission service module 170 of an electronic mail server 155. The electronic mail/document structurization DB 105 is a database managing a transmission mail 175 (which may include a document 140) transmitted from the electronic mail server 155. In other words, the electronic mail/document structurization DB 105 stores the transmission mail 175 transmitted from the electronic mail server 155. In a case where a document is associated with the transmission mail 175, the document 140 may be stored in that case. Here, the document 140 (also, referred to as a file), which is text data, numerical value data, graphic data, image data, moving image data, audio data, or a combination thereof, is a target of storage, editing, a search, and the like, indicates documents which are exchangeable between systems or users, and includes similarities thereto. Specifically, the document includes a document created by a document creation program, an image read by an image reading apparatus (a scanner or the like), or a web page. Specifically, the electronic mail/document structurization DB 105 stores a mail information table 400 which will be described later with reference to FIG. 4.

The information processing apparatus 100 may have a configuration of the electronic mail server 155.

In this case, the electronic mail/document structurization DB 105 may directly receive a transmission mail 150 from a mail sender terminal 130.

The difference extraction module 110 is connected to the electronic mail/document structurization DB 105 and the story extraction module 120. The difference extraction module 110 extracts a difference in a case where a document is updated (including, for example, revision). The document here is generated in association with a message in communication, and is generally completed through version-up. The difference generally indicates a difference between a target document and a document of the previous version of the target document, but is not limited thereto, and may be a difference between a target document and a document of a version (the prior version or the posterior version) which is different from a version of the target document. The difference may be calculated by using a well-known technique. For example, a “comparison” function, an “update history” function, or the like provided in a document creation program may be used. A version control system may be used. In a case where a URL of a storage destination of a document is described in text of a message, the version control system may be used.

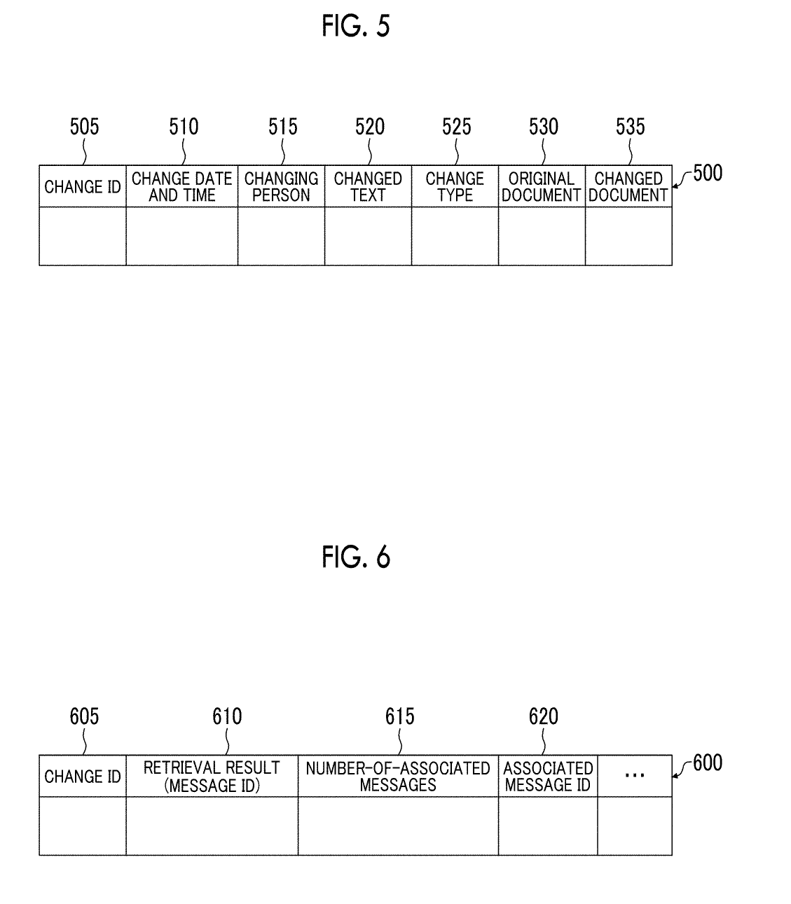

Specifically, the difference extraction module 110 generates a change table 500 which will be described later with reference to FIG. 5.

The topic classification module 115 is connected to the electronic mail/document structurization DB 105 and the story extraction module 120. The topic classification module 115 generates correspondence relationship information between messages by using a history of communication performed in association between a message and a document among a plurality of users. Here, the “association between a message and a document” includes that the document is directly attached to the message, or a location where the document is stored is described in the message. A “location storing a document” is, for example, a URL.

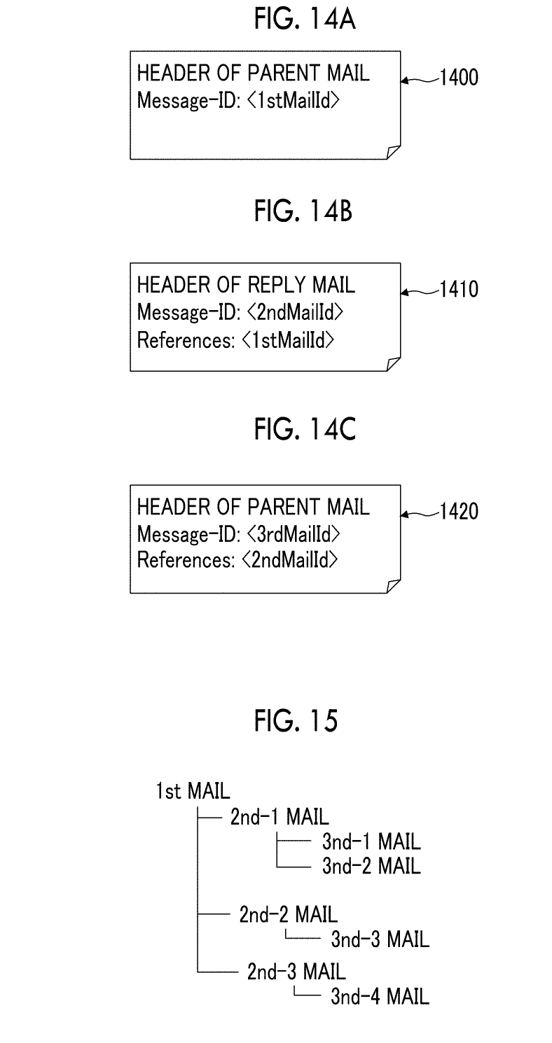

Regarding the “correspondence relationship”, in addition to a tree structure which will be described later, a correspondence relationship between messages may be specified by using “a “message ID” of an original message in “references”” of a reply electronic mail as which will be described later with reference to an example in FIG. 14A to 14C. Particularly in the latter case, graphic information such as a tree structure may not necessarily be generated.

The topic classification module 115 may generate correspondence relationship information between messages by using a quoted portion described in the messages. Here, the “quoted portion” indicates a portion to which text included in the previous message is copied without being changed in a case where messages are exchanged. The text may be a sentence, but may be not necessarily a sentence, and may be a part of a sentence or enumeration of words. Regarding extraction of the quoted portion, a quotation mark (for example, “>”) indicating the quoted portion may be retrieved, the quotation mark and a portion following the quotation mark may be extracted as the quoted portion; a word or the like (for example, “aforementioned”) indicating the quoted portion may be retrieved, and the word or the like and a portion following the word may be extracted as the quoted portion; and a sentence in a target sentence may be compared with a sentence in the previous message, and a matching portion may be extracted as the quoted portion.

In this case, the correspondence relationship information generated by the topic classification module 115 is generated for each topic (specifically, a quoted portion) in a discussion.

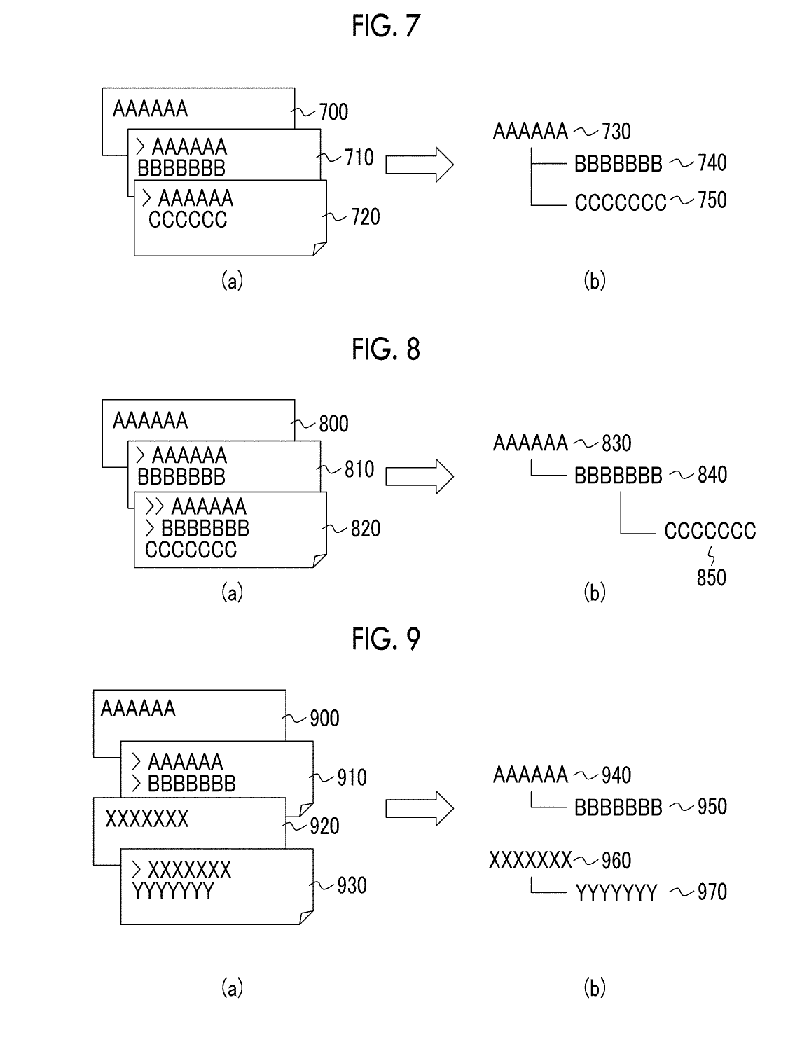

The topic classification module 115 may generate a tree structure as the correspondence relationship information, and may set a second message having the same text as a quoted portion in a first message, as the same hierarchy as that of the first message. Details thereof will be described later by using an example in FIG. 7.

The topic classification module 115 may generate a tree structure as the correspondence relationship information, and may set the second message having text other than a quoted portion in the first message as the quoted portion, as the lower hierarchy of the first message. The quoted portion may include a quotation mark. The topic classification module 115 may specify a message to be set as a higher rank of the second message on the basis of the number of quotation marks. Regarding “specifying a message serving as a higher rank of the second message on the basis of the number of quotation marks”, for example, the tree structure may be configured such that a message having the smallest number of quotation marks is set as a directly upper message. Details thereof will be described later by using an example in FIG. 8.

The topic classification module 115 may generate a tree structure as the correspondence relationship information, and may set a message as a root node in the tree structure in a case where the message does not have a quoted portion. Details thereof will be described later by using an example in FIG. 9.

The topic classification module 115 may generate the correspondence relationship information between messages by using information of a header portion of a message.

The topic classification module 115 may generate a tree structure as the correspondence relationship information.

The story extraction module 120 is connected to the difference extraction module 110, the topic classification module 115, and the web service module 125. The story extraction module 120 retrieves correspondence relationship information corresponding to a difference from a result obtained from the topic classification module 115, and extracts the corresponding correspondence relationship information as a change story. The correspondence relationship information here corresponds to in a discussion as described above, and thus a topic (specifically, one or more messages) associated with a difference in a document is extracted. For example, a series of messages indicates a flow of discussions until the difference in the document occurs (or after the difference occurs).

Specifically, the story extraction module 120 retrieves a difference from the correspondence relationship information, and extracts a message associated with the difference on the basis of a retrieval result in the correspondence relationship information.

The story extraction module 120 may use a quoted portion in a message forming the correspondence relationship information as a retrieval target. Here, “using quoted portion as a retrieval target” indicates that a difference is retrieved by using a quoted portion in a message as a retrieval target.

Specifically, the story extraction module 120 generates a document change/story information table 600 which will be described later with reference to FIG. 6.

The web service module 125 is connected to the story extraction module 120. The web service module 125 provides a user interface for story extraction.

Specifically, the web service module 125 presents a message extracted by the story extraction module 120 to a user of a story extracting person terminal 180.

In a case where the topic classification module 115 generates a tree structure as correspondence relationship information, the web service module 125 may present a message in a higher rank or a lower rank of a node including a difference.

The web service module 125 may present messages at a node including a difference in a time series.

The mail sender terminal 130 includes a document creation application module 135 and an electronic mail client module 145. The mail sender terminal 130 is a terminal for transmission and reception of electronic mails. For example, an operation is performed such that a document is shared as an attached file whenever the document is revised (updated). This operation may be defined as a discussion rule, and the electronic mail client module 145 transmits an electronic mail or prompts an electronic mail to be transmitted in a case of detecting that a document is revised.

The document creation application module 135 is connected to the electronic mail client module 145. The document creation application module 135 creates the document 140 in response to an operation of a user.

The document 140 is generated in a discussion using an electronic mail.

The electronic mail client module 145 is connected to the document creation application module 135, and an electronic mail DB 165 of an electronic mail service module 160 in the electronic mail server 155. The electronic mail client module 145 transmits the transmission mail 150 to a destination (which is a discussion partner and may be a plurality of persons) via the electronic mail server 155.

The transmission mail 150 may be associated with the document 140, and may not be associated with the document 140.

The electronic mail server 155 includes the electronic mail service module 160 and the mail transmission service module 170. The electronic mail server 155 is, for example, a mail server having an SMTP function, and has a function of transmitting an electronic mail received from the mail sender terminal 130 to a destination. The electronic mail server 155 may be a web mail system.

The electronic mail service module 160 includes the electronic mail DB 165. The electronic mail DB 165 is connected to the mail transmission service module 170, and the electronic mail client module 145 of the mail sender terminal 130. The electronic mail DB 165 stores the transmission mail 150 and the document 140 transmitted from the mail sender terminal 130.

The mail transmission service module 170 is connected to the electronic mail DB 165, and the electronic mail/document structurization DB 105 of the information processing apparatus 100. The mail transmission service module 170 transmits the transmission mail 150 in the electronic mail DB 165 to the information processing apparatus 100 as the transmission mail 175. For example, the transmission mail 150 from a predefined user may be selected from the electronic mail DB 165, and may be transmitted to the information processing apparatus 100.

The transmission mail 150 corresponding to a predefined combination of a sender and a receiver may be selected from the electronic mail DB 165, and may be transmitted to the information processing apparatus 100. The transmission mail 150 corresponding to a predefined combination of a sender and a receiver in a predefined period (a period in which a discussion is performed) may be selected from the electronic mail DB 165, and may be transmitted to the information processing apparatus 100.

The story extracting person terminal 180 is connected to the information processing apparatus 100. The story extracting person terminal 180 includes a web browser 185. The story extracting person terminal 180 is a terminal used by a user using the information processing apparatus 100, and is used by a user who desires to understand the generation process of a document which is generated as a result of a discussion.

The web browser 185 uses a web service function of the information processing apparatus 100. Specifically, the web browser 185 performs communication with the information processing apparatus 100, so as to present information (for example, home page information) presented by the web service module 125, and receives an operation of a user, and transmits the operation to the information processing apparatus 100.

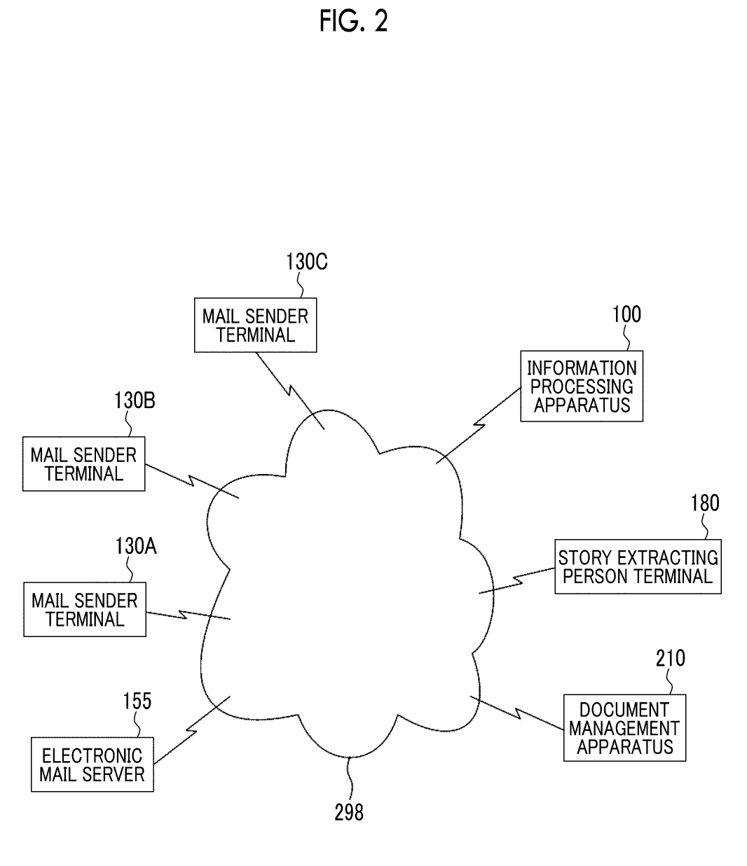

FIG. 2 is a diagram illustrating a system configuration example according to the present exemplary embodiment.

The information processing apparatus 100, a mail sender terminal 130A, a mail sender terminal 130B, a mail sender terminal 130C, the electronic mail server 155, the story extracting person terminal 180, and a document management apparatus 210 are connected to each other via a communication line 298. The communication line 298 may be a wireless line, a wired line, or a combination thereof, and may be, for example, a local area network (LAN), a public line, or the Internet or an intranet as a communication infrastructure. The information processing apparatus 100 presents electronic mails (electronic mails transmitted and received as discussions) associated with a difference caused by update of a document by using a correspondence relationship among the electronic mails. The function of the information processing apparatus 100 may be realized by a cloud service.

The mail sender terminal 130 is used by a participant in a discussion. The story extracting person terminal 180 is used by a user who extracts a story of the discussion. The story extracting person terminal 180 may be used by the participant in the discussion. The electronic mail server 155 performs a process of transmitting and receiving electronic mails exchanged among a plurality of mail sender terminals 130. As described above, in a case where a chat or a message transmission/reception function in an SNS other than an electronic mail is used as a communication tool, a system realizing the communication tool may be used instead of the electronic mail server 155.

As described above, regarding a form of “associating a document with a message”, in a case where a URL where a document is stored is described in a message instead of attaching the document to an electronic mail, the document management apparatus 210 (a storage location indicated by the URL) managing the document may be used.

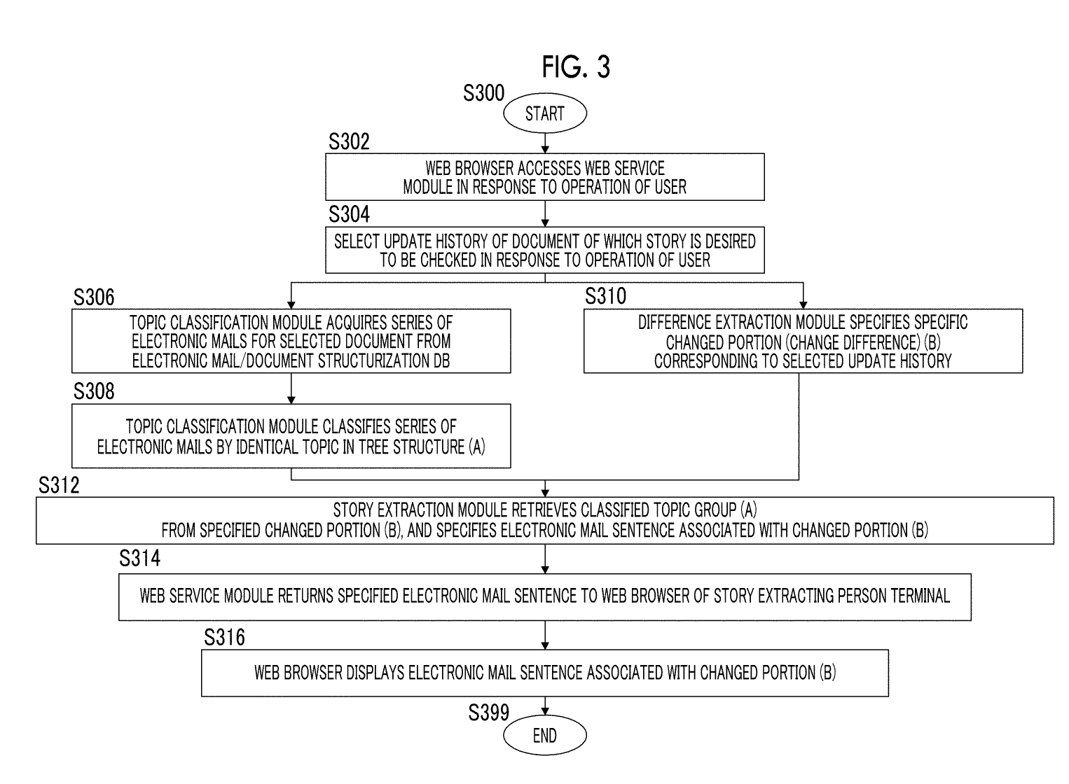

FIG. 3 is a flowchart illustrating a process example according to the present exemplary embodiment. FIG. 3 is a flowchart illustrating a case where a story regarding a difference between versions of the document 140 is displayed on the basis of information (the transmission mail 150 and the document 140) accumulated in the electronic mail/document structurization DB 105.

In step S302, the web browser 185 accesses the web service module 125 in response to an operation of a user.

In step S304, an update history of a document of which a story is desired to be checked is selected in response to an operation of the user.

In step S306, the topic classification module 115 acquires a series of electronic mails for the selected document from the electronic mail/document structurization DB 105.

In step S308, the topic classification module 115 classifies the series of electronic mails by an identical topic in a tree structure (A).

In step S310, the difference extraction module 110 specifies a specific changed portion (change difference) (B) corresponding to the selected update history.

Any one of the processes in step S306, step S308, and step S310 may be first performed, and the processes may be performed in parallel to each other.

In step S312, the story extraction module 120 retrieves the classified topic group (A) from the specified changed portion (B), and specifies an electronic mail sentence associated with the changed portion (B).

In step S314, the web service module 125 returns the specified electronic mail sentence to the web browser 185 of the story extracting person terminal 180.

In step S316, the web browser 185 displays the electronic mail sentence associated with the changed portion (B).

FIG. 4 is a diagram illustrating a data structure example of the mail information table 400. The mail information table 400 is accumulated in the electronic mail/document structurization DB 105.

The mail information table 400 has a message ID field 405, a transmission date and time field 410, a sender field 415, a number-of-destinations field 420, an opening date and time field 425, a receiver field 430, an attached document presence/absence field 435, an attached document field 440, and a mail content field 445. In the present exemplary embodiment, the message ID field 405 stores information (message identification (ID)) for uniquely identifying an electronic mail. The transmission date and time field 410 stores the date and time (which may be year, month, day, hour, minute, second, second or less, or a combination thereof) at which the electronic mail is transmitted. The sender field 415 stores a sender of the electronic mail (a user ID or the like). The number-of-destinations field 420 stores the number of destinations of the electronic mail. A set of the opening date and time field 425 and the receiver field 430 corresponding to the number of destinations follows the number-of-destinations field 420. The opening date and time field 425 stores the date and time at which the electronic mail is opened. The receiver field 430 stores a receiver (a user ID or the like) of the electronic mail. The attached document presence/absence field 435 stores the presence or absence of an attached document in the electronic mail. Of course, the attached document may include a case where a URL of the data is described in a message in addition to a case where the document is directly attached as described above. The attached document field 440 stores the attached document.

The document may be stored, and a URL where the document is stored may be stored. The mail content field 445 stores a content of the electronic mail.

For example, FIG. 4 illustrates an electronic mail with a message ID: 0001 of which the transmission date and time is “2016/12/12, 10:00:00”, a sender is a “user C”, the number of destinations is “two”, the opening date and time is “2016/12/12, 11:00:00”, an opening receiver is a “user B”, there is an attached document, and the attached document is a “D document”, and a content of the electronic mail is “XXXXXXXXXX”.

FIG. 5 is a diagram illustrating a data structure example of the change table 500. The change table 500 is generated by the difference extraction module 110.

The change table 500 has a change ID field 505, a change date and time field 510, a changing person field 515, a changed text field 520, a change type field 525, an original document field 530, and a changed document field 535. The change ID field 505 stores information (change ID) for uniquely identifying a change of a document in the present exemplary embodiment. The change date and time field 510 stores the date and time at which the change is performed. The changing person field 515 stores a user (a user ID or the like) who performs the change. The changed text field 520 stores changed text. For example, the changed text includes added text, replaced text, and deleted text. A set of pieces of text before and after being changed may be stored, and a position of a changed portion (a position specified by the number of letters from the head, or a page number, a row number, or the number of letters from the head of a row) may be stored. The change type field 525 stores a change type. For example, there is an addition, a replacement, or a deletion. The original document field 530 stores an original document compared with a document in the changed document field 535. The changed document field 535 stores a changed document which is a target.

FIG. 6 is a diagram illustrating a data structure example of the document change/story information table 600. The document change/story information table 600 is generated by the story extraction module 120.

The document change/story information table 600 has a change ID field 605, a retrieval result (message ID) field 610, a number-of-associated messages field 615, and an associated message ID field 620. The change ID field 605 stores a change ID. The retrieval result (message ID) field 610 stores retrieval results (one or more message IDs). The number-of-associated messages field 615 stores the number of associated messages. The associated message ID field 620 follows the number-of-associated messages field 615 by the number of associated messages. The associated message ID field 620 stores an associated message ID.

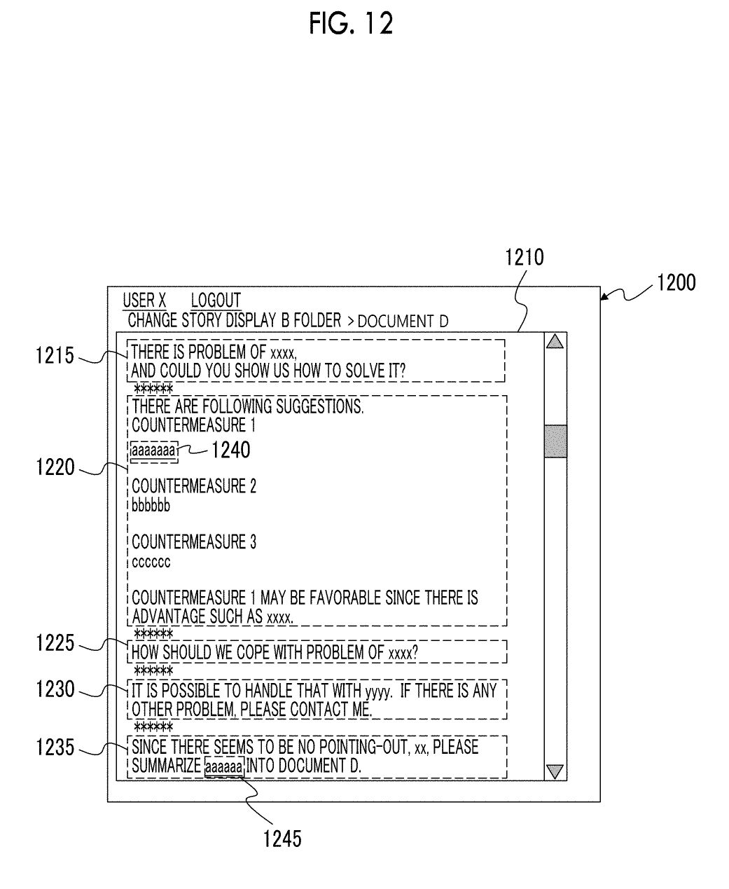

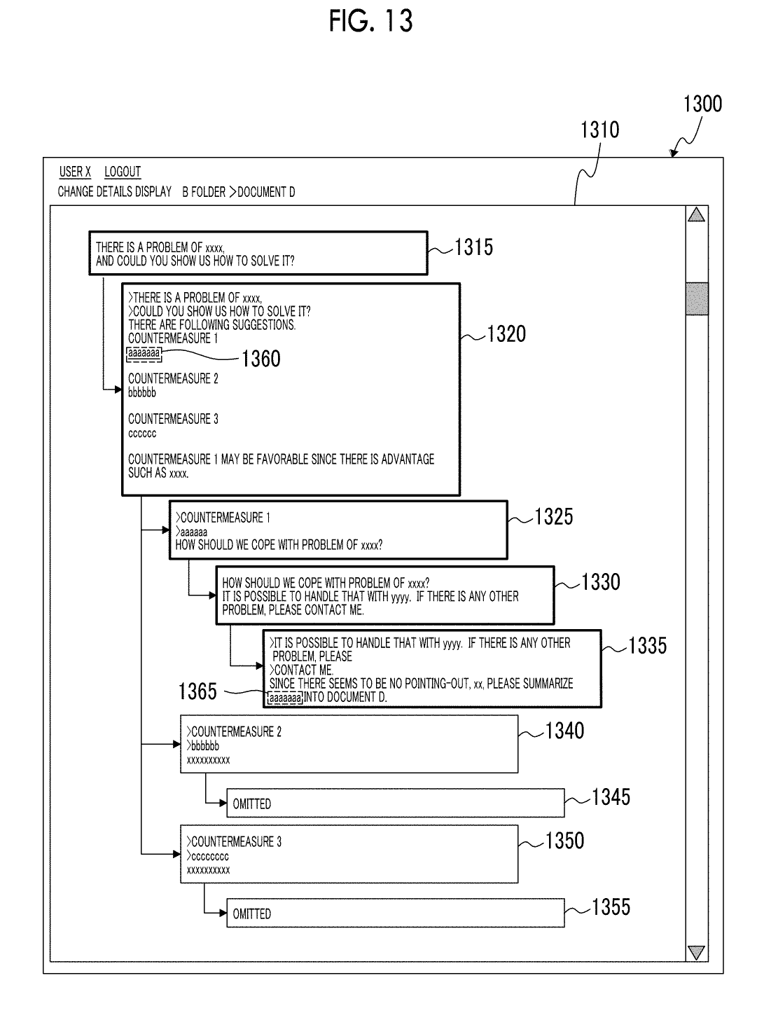

The web service module 125 generates screens (for example, a screen 1200 and a screen 1300 which will be described later by using examples in FIGS. 12 and 13) to be displayed on the web browser 185 on the basis of the document change/story information table 600, the change table 500 corresponding to a change ID, and the mail information table 400 corresponding to an associated message ID.

A description will be made of a process example in the topic classification module 115 with reference to FIGS. 7 to 9.

FIG. 7 is a diagram illustrating a process example according to the present exemplary embodiment. FIG. 7 illustrates an example in which, in a case where identical text is quoted, classification as an identical hierarchy is performed. In other words, the example is an example in which an electronic mail sentence 720 having the same text as a quoted portion in an electronic mail sentence 710 as a quoted portion is set as the same hierarchy as that of the electronic mail sentence 710.

“AAAAAA” is described in an electronic mail sentence 700.

“>AAAAAA” which is a quotation sentence and “BBBBBBB” which is not a quotation sentence are described in the electronic mail sentence 710 which is transmitted after the electronic mail sentence 700. Quotation marks other than “>” may be used.

“>AAAAAA” which is a quotation sentence and “CCCCCCC” which is not a quotation sentence are described in the electronic mail sentence 720 which is transmitted after the electronic mail sentence 710.

The quoted portion in the electronic mail sentence 710 is the same as the quotation sentence in the electronic mail sentence 720, and thus the electronic mail sentence 710 and the electronic mail sentence 720 are located in an identical hierarchy. The term “identical” may include not only complete matching but also obscure matching. Including obscure matching can cope with automatic line feeding or correction of a word in the electronic mail client module 145.

Through this process, a tree structure illustrated in an example in (b) of FIG. 7 is generated. (b) of FIG. 7 illustrates an example in which a tree structure having a node 740 and a node 750 directly under a node 730 is generated.

FIG. 8 is a diagram illustrating a process example according to the present exemplary embodiment. In a case where a new quotation sentence is used, the quotation sentence is classified as a child hierarchy. In other words, FIG. 8 illustrates an example in which an electronic mail sentence 820 having text other than a quoted portion in an electronic mail sentence 810 as a quoted portion is set as a lower hierarchy of the electronic mail sentence 810.

“AAAAAA” is described in an electronic mail sentence 800.

“>AAAAAA” which is a quotation sentence and “BBBBBBB” which is not a quotation sentence are described in the electronic mail sentence 810 which is transmitted after the electronic mail sentence 800.

“>>AAAAAA” which is a quotation sentence, “>BBBBBBB” which is a quotation sentence, and “CCCCCCC” which is not a quotation sentence are described in the electronic mail sentence 820 which is transmitted after the electronic mail sentence 810.

The electronic mail sentence 820 includes “BBBBBBB” in the electronic mail sentence 810, and is thus set as a child hierarchy of the electronic mail sentence 810.

Through this process, a tree structure illustrated in an example in (b) of FIG. 8 is generated. (b) of FIG. 8 illustrates an example in which a tree structure having a node 840 directly under a node 830 and having a node 850 directly under the node 840 is generated.

In a case where there is the electronic mail sentence 820 which further quotes “BBBBBBB” in the electronic mail sentence 810 which quotes “AAAAAA” in the electronic mail sentence 800, the electronic mail sentence 820 is classified to be located at a grandchild position in a case of being viewed from the electronic mail sentence 800.

In the example in FIG. 8, “>>AAAAAA” is described, but there is a high probability that an old quoted portion may be omitted during long exchanges. Therefore, in a case where only the latest “>BBBBBBB” is present in the electronic mail sentence 820, a tree structure is assumed to be able to be generated. The term “latest” indicates that there is a single quoted portion “>”.

In a case where a plurality of quoted portions are described, a parent may be determined according to the following rules.

(Rule 1) A message including text in a quoted portion having a smallest number of quotation marks (“>”) is set as an immediately upper parent.

(Rule 2) Among a plurality of quoted portions, a message including text in the lowest quoted portion in a message is set as a directly upper parent.

In the example illustrated in (a) of FIG. 8, in either rule, the electronic mail sentence 810 is a directly upper parent of the electronic mail sentence 820. In other words, the electronic mail sentence 810 including the text “BBBBBBB” of the quoted portion “>BBBBBBB” having a single quotation mark “>” in the electronic mail sentence 820 becomes a parent. The electronic mail sentence 810 including the text “BBBBBBB” of the quoted portion “>BBBBBBB” described in the lowest part in the electronic mail sentence 820 becomes a parent.

FIG. 9 is a diagram illustrating a process example according to the present exemplary embodiment. In a case where an electronic mail not having a quoted portion is used as a quoted portion of another electronic mail, the electronic mail not having a quoted portion is set as a root node. In other words, FIG. 9 illustrates an example in which, in a case of an electronic mail sentence 920 not having a quoted portion in a message, the electronic mail sentence 920 is set as a root node in a tree structure.

“AAAAAA” is described in an electronic mail sentence 900.

“>AAAAAA” which is a quotation sentence and “BBBBBBB” which is not a quotation sentence are described in the electronic mail sentence 910 which is transmitted after the electronic mail sentence 900.

“XXXXXXX” which is not a quotation sentence is described in the electronic mail sentence 920 which is transmitted after the electronic mail sentence 910.

“>XXXXXXX” which is a quotation sentence and “YYYYYYY” which is not a quotation sentence are described in the electronic mail sentence 930 which is transmitted after the electronic mail sentence 920.

Since there is no quotation sentence in the electronic mail sentence 920, and the text in the electronic mail sentence 920 is a quotation sentence in the electronic mail sentence 930, the electronic mail sentence 920 is set as a root node, and the electronic mail sentence 930 is set as a child hierarchy.

Through this process, a tree structure illustrated in an example in (b) of FIG. 9 is generated. (b) of FIG. 9 illustrates an example of two tree structures such as a tree structure having a node 950 directly under a node 940 and a tree structure having a node 970 directly under a node 960.

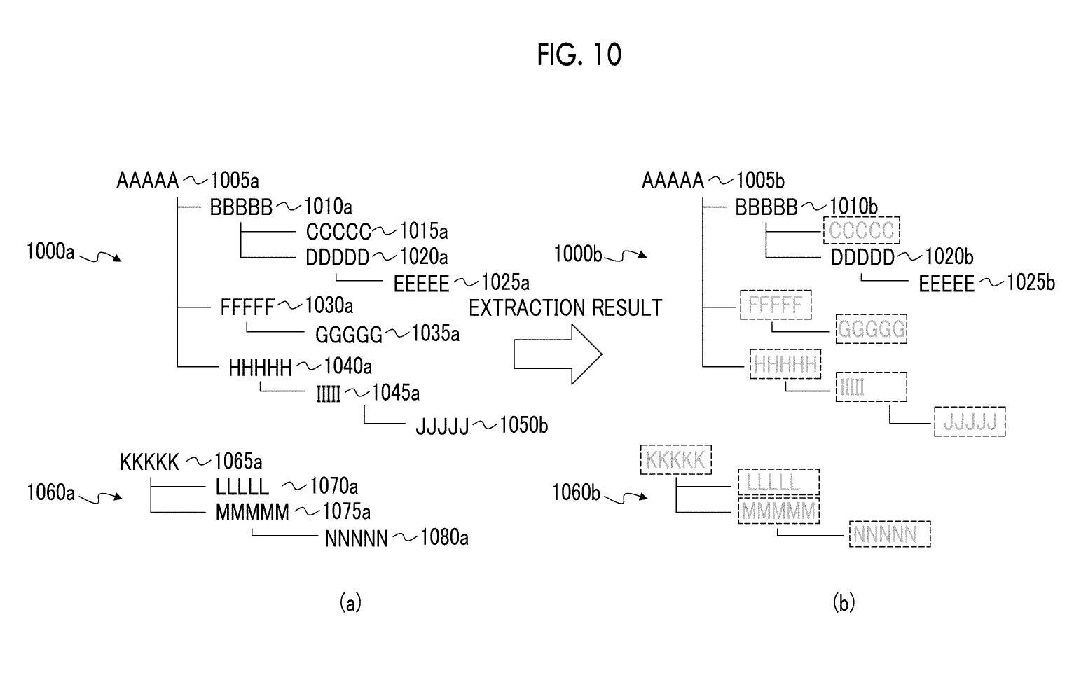

FIG. 10 is a diagram illustrating a process example according to the present exemplary embodiment. FIG. 10 illustrates a process example performed by the story extraction module 120. Here, a difference extracted by the difference extraction module 110 is used as retrieval text, and is retrieved from a tree structure created by the topic classification module 115. Specifically, a difference “EEEEE” is retrieved from is retrieved from a tree structure 1000a of a topic group A1 and a tree structure 1000b of a topic group B1.

In the tree structure 1000a of the topic group A1, there are a node 1010a, a node 1030a, and a node 1040a directly under a node 1005a; there are a node 1015a and a node 1020a directly under the node 1010a; there is a node 1025a directly under the node 1020a; there is a node 1035a directly under the node 1030a; there is a node 1045a directly under the node 1040a; and there is a node 1050a directly under the node 1045a.

In a tree structure 1060a of a topic group A2, there are a node 1070a and a node 1075a directly under a node 1065a; and there is a node 1080a directly under the node 1075a.

The difference “EEEEE” is present in the tree structure 1000a of the topic group A1 (node 1025a), and is not present in the tree structure 1060a of a topic group A2. Therefore, the story extraction module 120 extracts the tree structure 1000b of the topic group B1 from the tree structure 1000a of the topic group A1, and extracts a tree structure 1060b (vacant) of a topic group B2 from the tree structure 1060a of a topic group A2. As an extraction result, the tree structure 1000b of the topic group B1 is generated which has a node 1010b directly under a node 1005b, a node 1020b directly under the node 1010b, and a node 1025b directly under the node 1020b. In other words, the structure is generated by extracting the node 1020b which is a directly upper parent of the node 1025a, the node 1010b which is a directly upper node of the node 1020b, and the node 1005b which is a directly upper parent of the node 1010b. Consequently, messages in a discussion until the difference “EEEEE” occurs can be specified. In a case where the node 1025a has a child node, the child node may be extracted.

In this case, messages in a discussion after the difference “EEEEE” occurs can be specified.

The tree structure 1060b of the topic group B2 is vacant (NULL), and thus a topic discussed in the tree structure 1060b of the topic group B2 has no relation to the difference “EEEEE”.

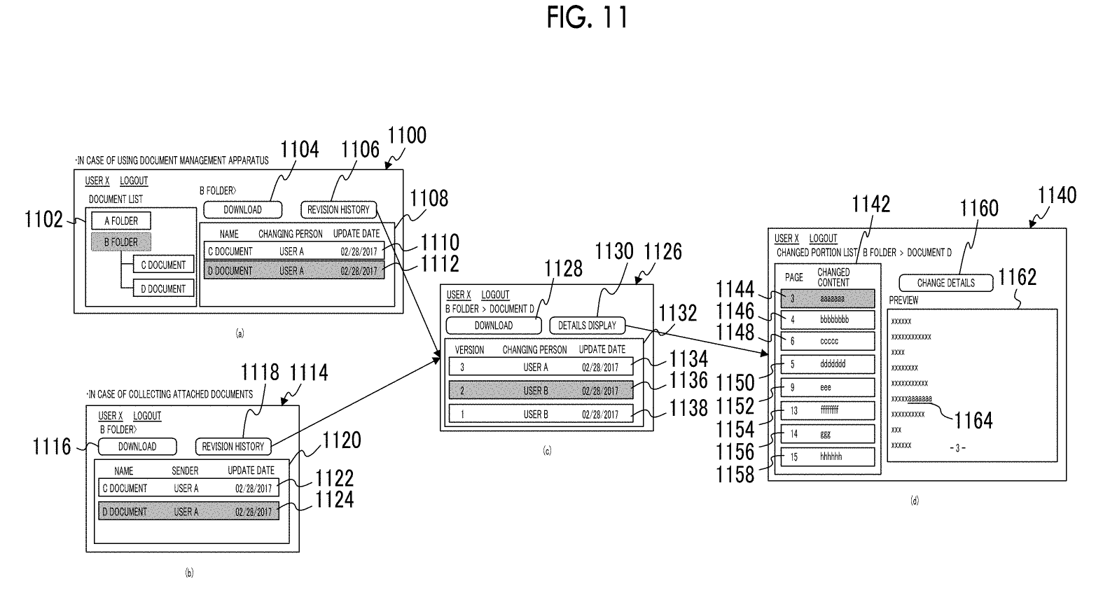

FIG. 11 is a diagram illustrating a display example according to the present exemplary embodiment. FIG. 11 illustrates an example of a screen (a screen displayed on the web browser 185) generated by the web service module 125.

The user specifies a document by using the story extracting person terminal 180. There are two methods regarding this specifying operation. One is that a document is specified by using the document management apparatus 210 as illustrated in the example in (a) of FIG. 11. An attached file (an example of a document associated with a message) of an electronic mail is stored in the document management apparatus 210. The other is that a document is specified by using an attached document (an example of a document associated with a message) of an electronic mail as illustrated in the example in (b) of FIG. 11.

In the example illustrated in (a) of FIG. 11, a document list display region 1102, a download button 1104, a revision history button 1106, and a document list region 1108 are displayed on a screen 1100 of the story extracting person terminal 180.

An A folder and a B folder are present in the document list display region 1102, and a C document and a D document are present in the B folder. In this example, the B folder is selected (clicked) through an operation of the user.

Details (an attribute and the like) of a document in the B folder are displayed in the document list region 1108. A document field 1110 and a document field 1112 are displayed in the document list region 1108.

The name “C document”, an updater “user A”, and the update date “2017/02/28” are displayed in the document field 1110.

The name “D document”, an updater “user A”, and the update date “2017/02/28” are displayed in the document field 1112.

In this case, the document field 1112 (D document) is selected through an operation of the user. In a case where the revision history button 1106 is selected, the screen transitions to a screen 1126 illustrated in the example in (c) of FIG. 11.

In the example in (b) of FIG. 11, a download button 1116, a revision history button 1118, and a document list region 1120 are displayed on a screen 1114 of the story extracting person terminal 180. A document field 1122 and a document field 1124 are displayed in the document list region 1120.

The name “C document”, an updater “user A”, and the update date “2017/02/28” are displayed in the document field 1122.

The name “D document”, an updater “user A”, and the update date “2017/02/28” are displayed in the document field 1124.

In this case, the document field 1124 (D document) is selected through an operation of the user. In a case where the revision history button 1118 is selected, the screen transitions to a screen 1126 illustrated in the example in (c) of FIG. 11.

In the example in (c) of FIG. 11, a download button 1128, a details display button 1130, and a version list region 1132 are displayed on a screen 1126 of the story extracting person terminal 180. In other words, a version of the D document is displayed. The D document has three versions, and a version field 1134, a version field 1136, and a version field 1138 are displayed.

Version “3”, an updater “user A”, and the update date “2017/02/28” are displayed in the version field 1134.

Version “2”, an updater “user B”, and the update date “2017/01/01” are displayed in the version field 1136.

Version “1”, an updater “user C”, and the update date “2016/12/12” are displayed in the version field 1138.

In this case, the version field 1136 (the version “2” of the D document) is selected through an operation of the user. In a case where the details display button 1130 is selected, the screen transitions to a screen 1140 illustrated in the example in (d) of FIG. 11.

In the example in (d) of FIG. 11, a changed portion list region 1142, a change story button 1160, and a preview region 1162 are displayed in a screen 1140 of the story extracting person terminal 180. In other words, in a case where the details display button 1130 in the example in (c) of FIG. 11 is selected, and thus the D document is changed from the version “1” to the version “2”, a changed content is displayed. In other words, a difference between version 1 and version 2 of the D document is displayed.

A changed portion field 1144, a changed portion field 1146, a changed portion field 1148, a changed portion field 1150, a changed portion field 1152, a changed portion field 1154, a changed portion field 1156, and a changed portion field 1158 are displayed in the changed portion list region 1142.

Page “3” and a changed content “aaaaaaa” are displayed in the changed portion field 1144. Page “4” and a changed content “bbbbbbbb” are displayed in the changed portion field 1146. Page “6” and a changed content “ccccc” are displayed in the changed portion field 1148. Page “5” and a changed content “ddddddd” are displayed in the changed portion field 1150. Page “9” and a changed content “eee” are displayed in the changed portion field 1152. Page “13” and a changed content “ffffffff” are displayed in the changed portion field 1154. Page “14” and a changed content “ggg” are displayed in the changed portion field 1156. Page “15” and a changed content “hhhhhh” are displayed in the changed portion field 1158.

This example illustrates that the changed portion field 1144 (a change in page 3) is selected through an operation of the user. The content of page 3 is displayed in the preview region 1162.

A difference portion is underlined and displayed as in a changed portion 1164.

Thereafter, in a case where the change story button 1160 is selected, the screen transitions to the screen 1200 illustrated in the example in FIG. 12 corresponding to simple version display or to the screen 1300 illustrated in the example in FIG. 13 corresponding to detailed version display with respect to a discussion until the difference portion occurs or a discussion after the difference portion occurs.

FIG. 12 is a diagram illustrating a display example according to the present exemplary embodiment. FIG. 12 illustrates an electronic mail associated with the changed content “aaaaaaa”. An electronic mail including the changed content “aaaaaaa” is displayed, and an electronic mail group having a relationship of a parent or a child with the electronic mail (the content corresponding to the tree structure 1000b of the topic group B1 illustrated in the example in (b) of FIG. 10). The electronic mail group is displayed in a time series in the example in FIG. 12.

A change story display region 1210 is displayed on the screen 1200 of the story extracting person terminal 180.

An electronic mail sentence 1215, an electronic mail sentence 1220, an electronic mail sentence 1225, an electronic mail sentence 1230, and an electronic mail sentence 1235 are displayed in the change story display region 1210.

In the electronic mail sentence 1220, a document changed portion 1240 is underlined and displayed red. In the electronic mail sentence 1235, a document changed portion 1245 is underlined and displayed red.

FIG. 13 is a diagram illustrating a display example according to the present exemplary embodiment. Electronic mails associated with the changed content “aaaaaaa” are displayed. An electronic mail including the changed content “aaaaaaa” is displayed, and an electronic mail group having a relationship of a parent or a child with the electronic mail (the content corresponding to the tree structure 1000b of the topic group B1 illustrated in the example in (b) of FIG. 10).

The electronic mail group is displayed in a time series and graphically in the example in FIG. 13.

A change story display region 1310 is displayed on the screen 1300 of the story extracting person terminal 180.

An electronic mail sentence 1315, an electronic mail sentence 1320, an electronic mail sentence 1325, an electronic mail sentence 1330, an electronic mail sentence 1335, an electronic mail sentence 1340, an electronic mail sentence 1345, an electronic mail sentence 1350, and an electronic mail sentence 1355 are displayed in the change story display region 1310.

An example of a tree structure is illustrated which has the electronic mail sentence 1320 directly under the electronic mail sentence 1315; the electronic mail sentence 1325, the electronic mail sentence 1340, and the electronic mail sentence 1350 directly under the electronic mail sentence 1320; the electronic mail sentence 1330 directly under the electronic mail sentence 1325; the electronic mail sentence 1335 directly under the electronic mail sentence 1330; the electronic mail sentence 1345 directly under the electronic mail sentence 1340; and the electronic mail sentence 1355 directly under the electronic mail sentence 1350.

In the electronic mail sentence 1320, a document changed portion 1360 is underlined and displayed red. In the electronic mail sentence 1335, a document changed portion 1365 is underlined and displayed red. The electronic mail sentence 1315, the electronic mail sentence 1320, the electronic mail sentence 1325, the electronic mail sentence 1330, and the electronic mail sentence 1335 are displayed with thick frames, so as to be differentiated from the electronic mail sentence 1340 or the like which has no relation to the changed content “aaaaaaa”. The electronic mail sentence 1320 and the electronic mail sentence 1335 including the changed content “aaaaaaa” are displayed with red thick frames.

In the above example, the correspondence relationship information is generated by using a quoted portion, but the correspondence relationship information may be generated by using header information of a message.

For example, electronic mails can be expressed in a tree structure by using a reply function of a mail client.

A “Message-ID” tag and a “References” tag are present in the header of an electronic mail, and a “Message-ID” of an original mail is described in the “References” tag of a reply mail. For example, this is illustrated in examples in FIGS. 14A to 14C.

There is “Message-ID: <1stMailId>” as the header 1400 of a new mail.

There are “Message-ID: <2ndMailId> and References: <1stMailId>” as the header 1410 of a reply mail.

There are “Message-ID: <3rdMailId> and References: <2ndMailId>” as the header 1420 of a further reply mail.

From this, there may be the generation of a tree structure in which the header 1400 of the new mail is set as root node, the header 1410 of the reply mail is set as a child node directly thereunder; the header 1410 of the reply mail is set as a child node directly thereunder; and the header 1420 of the reply mail is set as a child node directly under the header 1410 of the reply mail.

A target range of an electronic mail may be set impedance generation of correspondence relationship information between messages.

(S1) An electronic mail to which a selected document is attached is extracted.

(S2) An ancestor electronic mail (initial electronic mail) of the electronic mail extracted in (S1) is extracted.

(S3) All descendant electronic mails of the antecedent electronic mail are extracted. These are set as an electronic mail group of a target range.

Correspondence relationship information between messages may be generated by using a quoted portion within the target range.

FIG. 15 is a diagram illustrating a process example according to the present exemplary embodiment.

FIG. 15 illustrates an example of a tree structure which has a “2nd-1 mail”, a “2nd-2 mail”, and a “2nd-3 mail” directly under a “1st mail”; a “3rd-1 mail” and a “3rd-2 mail” directly under the “2nd-1 mail”; a “3nd-3 mail” directly under the “2nd-2 mail”; and a “3rd-4 mail” directly under the “2nd-3 mail”.

The electronic mail “3rd-1 mail” to which a selected document is attached is extracted through an operation of the user (S1). The mail dates back to the ancestor “1st mail” (S2). Retrieval target electronic mails are all descendant mail following the 1st mail (S3). In other words, all electronic mails in an identical tree are targets.

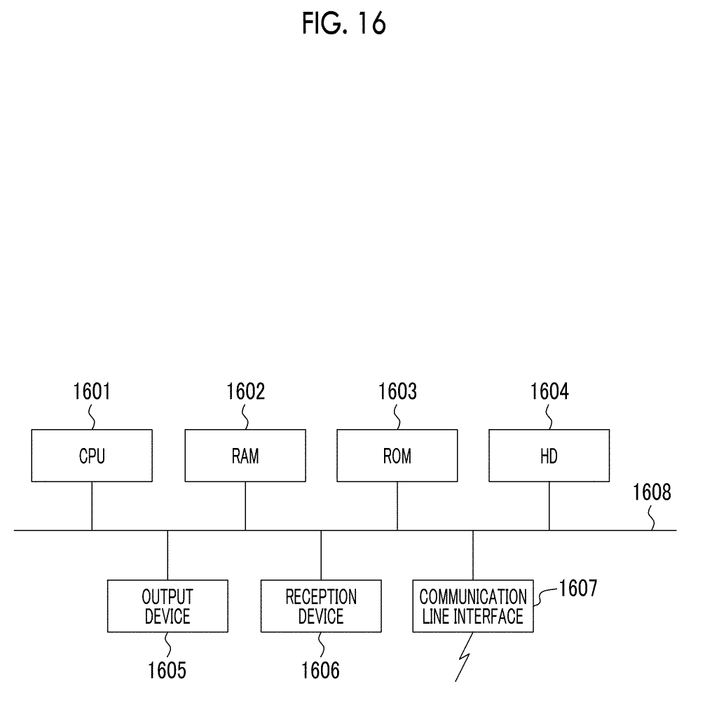

A hardware configuration of a computer executing a program as the present exemplary embodiment is a hardware configuration of a general computer as exemplified in FIG. 16, and the computer is, specifically, a personal computer or a computer serving as a server. In other words, as a specific example, a CPU 1601 is used as a processing unit (calculation unit), and a RAM 1602, a ROM 1603, and an HD 1604 are used as a storage device. For example, a hard disk or a solid state drive (SSD) may be used as the HD 1604. The computer includes the CPU 1601 executing programs such as the difference extraction module 110, the topic classification module 115, the story extraction module 120, the web service module 125, the document creation application module 135, the electronic mail client module 145, the electronic mail service module 160, the mail transmission service module 170, and the web browser 185; the RAM 1602 storing the programs or data; the ROM 1603 storing a program or the like for activing the computer; the HD 1604 which is an auxiliary storage device (which may be a flash memory or the like) functioning as the electronic mail/document structurization DB 105 and the electronic mail DB 165; a reception device 1606 which receives data on the basis of a user's operation (including an action, a voice, a visual line, and the like) on a keyboard, a mouse, a touch screen, a microphone, or a microphone (including a visual line detection camera or the like); an output device 1605 such as a CRT, a liquid crystal display, or a speaker; a communication line interface 1607 for connection to a communication network such as a network interface card; and a bus 1608 connecting the above-described elements to each other for exchanging data. Such a plurality of computers may be connected to each other via a network.

Among the above-described exemplary embodiments, in a case of the exemplary embodiment based on a computer program, the computer program which is software is read to a system having the present hardware configuration, and the exemplary embodiment is realized through cooperation between the software and the hardware resources.

The hardware configuration illustrated in FIG. 16 corresponds to one configuration example, and the present exemplary embodiment is not limited to the configuration illustrated in FIG. 16, and any configuration in which the modules described in the present exemplary embodiment can be executed may be used. For example, some of the modules may be configured with dedicated hardware (for example, an application specific integrated circuit (ASIC)), some of the modules may be provided in an external system, and may be connected to a communication line, and such a plurality of systems illustrated in FIG. 16 may be connected to each other via a communication line so as to operate in cooperation therebetween. Particularly, the modules may be incorporated not only into a personal computer but also into a portable information communication apparatus (including a mobile phone, a smart phone, a mobile apparatus, a wearable computer, and the like), an information appliance, a robot, a copier, a facsimile, a scanner, a printer, a multi-function peripheral (an image processing apparatus having two or more functions of a scanner, a printer, copier, and a facsimile).

The program may be stored on a recording medium so as to be provided, and the program may be provided by using a communication unit. In this case, for example, the program may be understood as the invention of a “non-transitory computer readable medium storing the program”.

The “non-transitory computer readable medium storing the program” indicates a computer readable recording medium storing the program, used to install, execute, and distribute the program.

The recording medium includes, for example, “a DVD-R, a DVD-RW, a DVD-RAM, or the like” which is a digital versatile disc (DVD) and is a standard defined in the DVD forum, and “a DVD+R, DVD+RW, or the like” which is a standard defined in the DVD+RW, a compact disc (CD) read only memory (CD-ROM), a CD recordable (CD-R), or a CD rewritable (CD-RW), a Blu-ray (registered trademark) disc, a magnetooptical disc (MO), a flexible disk (FD), a magnetic tape, a hard disk, a read only memory (ROM), an electrically erasable programmable read only memory (EEPROM) (registered trademark), a flash memory, a random access memory (RAM), and a secure digital (SD) memory card.

The whole or a part of the program may be recorded on the recording medium so as to be preserved or distributed. The program may be transmitted through communication, for example, by using a transmission medium such as a wired network used for a local area network (LAN), a metropolitan area network (MAN), a wide area network (WAN), the Internet, an intranet, or an extranet, a wireless communication network, or a combination thereof, and may be carried via a carrier wave mounted therewith.

The program may be a part or the whole of another program, or may be recorded on a recording medium along with a separate program. The program may be divided and recorded on a plurality of recording media. The program may be recorded in any restorable aspect such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a generation unit that generates correspondence relationship information between messages by using a history of communication which is performed by associating a document with the messages among a plurality of users;
an extraction unit that extracts a difference in a case where the document is updated; and
a presentation unit that retrieves the difference from the correspondence relationship information, and presents a message on the basis of a retrieval result in the correspondence relationship information.

2. The information processing apparatus according to claim 1,
wherein the generation unit generates the correspondence relationship information between the messages by using a quoted portion described in a message.

3. The information processing apparatus according to claim 2,
wherein the generation unit generates a tree structure as the correspondence relationship information, and sets a second message having the same text as a quoted portion in a first message as a quoted portion, as the same hierarchy as a hierarchy of the first message.

4. The information processing apparatus according to claim 2,
wherein the generation unit generates a tree structure as the correspondence relationship information, and sets a second message having text other than a quoted portion in a first message as a quoted portion, as a lower hierarchy of the first message.

5. The information processing apparatus according to claim 4,
wherein the quoted portion has a quotation mark, and
wherein the generation unit specifies a message to be set as a higher rank of the second message on the basis of the number of quotation marks.

6. The information processing apparatus according to claim 2,
wherein the generation unit generates a tree structure as the correspondence relationship information, and sets a message as a root node in the tree structure in a case where there is no quoted portion in the message.

7. The information processing apparatus according to claim 2,
wherein a quoted portion of a message forming the correspondence relationship information is set as a target of the retrieval.

8. The information processing apparatus according to claim 1,
wherein the generation unit generates the correspondence relationship information between the messages by using information of a header portion of a message.

9. The information processing apparatus according to claim 1,
wherein the generation unit generates a tree structure as the correspondence relationship information, and
wherein the presentation unit presents a message in a higher rank or a lower rank of a node including the difference.

10. The information processing apparatus according to claim 9,
wherein the presentation unit presents messages at the node including the difference in a time series.

11. A non-transitory computer readable medium storing an information processing program causing a computer to function as:
a generation unit that generates correspondence relationship information between messages by using a history of communication which is performed by associating a document with the messages among a plurality of users;
an extraction unit that extracts a difference in a case where the document is updated; and
a presentation unit that retrieves the difference from the correspondence relationship information, and presents a message on the basis of a retrieval result in the correspondence relationship information.

12. An information processing apparatus comprising:
generation means for generating correspondence relationship information between messages by using a history of communication which is performed by associating a document with the messages among a plurality of users;
extraction means for extracting a difference in a case where the document is updated; and
presentation means for retrieving the difference from the correspondence relationship information, and presenting a message on the basis of a retrieval result in the correspondence relationship information.
